(19) United States
(12) Patent Application Publication
(10) Pub. No.: US 2026/0281531 A1
(43) Pub. Date: Sep. 17, 2026

(54) MODULAR IMAGING TRAYS FOR VEHICLES

(71) Applicant: BWI Acquisition, Inc., Chesterfield, MO (US)

(72) Inventors: Darren R. Kemper, Chesterfield, MO (US); Christopher L. Dillow, Chesterfield, MO (US); James M. Commons, Chesterfield, MO (US)

(21) Appl. No.: 19/563,030

(22) Filed: Mar. 11, 2026

Related U.S. Application Data
(60) Provisional application No. 63/895,705, filed on Oct. 8, 2025.
(60) Provisional application No. 63/769,870, filed on Mar. 11, 2025.

(51) Int. Cl. H04N 23/50; H04N 7/18; H04N 23/56; H04N 23/60; H04N 23/90

(52) U.S. Cl. CPC H04N 23/555; H04N 7/181; H04N 23/56; H04N 23/64; H04N 23/90

(57) ABSTRACT

A modular imaging system for a vehicle includes modular imaging trays. The modular imaging trays include a first end and a second end opposite the first end. The first end of one of the modular imaging trays is connectable to a second end of an adjacent one of the modular imaging trays. Each of the modular imaging trays include a top panel; one or more cameras for taking images of a vehicle through the top panel; one or more lighting sources for illuminating the vehicle; at least one angled side surface adjacent to the top panel that encloses a subset of the one or more lighting sources and transmits light from the subset of the one or more lighting sources toward the vehicle; a projection on the first end of the modular imaging tray; and a recess on a second end of the modular imaging tray.

### CROSS REFERENCE TO RELATED APPLICATIONS

This application claims the benefit of U.S. Provisional Patent Application No. 63/769,870 filed Mar. 11, 2025 and U.S. Provisional Patent Application No. 63/895,705 filed Oct. 9, 2025. The entire contents of the above applications are incorporated herein by reference in their entireties for all purposes.

### TECHNICAL FIELD

This disclosure relates generally to an imaging system that captures images of the undercarriage of vehicles, such as cars, trucks, boats, recreational vehicles, trailers, buses, semi-tractor trailers, tankers, military equipment, and heavy duty equipment.

### BACKGROUND

Automobile dealers often purchase vehicles on the wholesale market, which may occur via in-person and online auctions. Due to the large volume of vehicles sold at auctions, it is not always possible for the dealer to inspect a vehicle. Dealers often rely on auction operators to provide vehicle condition data upon which purchasing decisions may be made. This vehicle condition data is often provided to dealers as an electronic inspection report.

The value of a vehicle condition report is based, in large part, on the accuracy and completeness of the inspection report. However, information about a vehicle’s undercarriage features such as rust, flood damage, tire damage, wheel damage, frame damage, missing components, etc. are not easily observed and captured in the vehicle condition report.

In addition to auction settings, the data related to the vehicle’s undercarriage features is helpful for other services as well. For example, the condition of the undercarriage is important for rental car companies when the car is returned to ensure that no undercarriage damage has occurred. The condition of the undercarriage is also helpful at a dealer service center to quickly identify problems with the undercarriage of the vehicle when the car is being serviced.

The primary challenge of determining the conditions of the vehicle undercarriage is the difficulty in the inaccessibility of the vehicle undercarriage. Lifting the vehicle to gain access is time consuming. Known undercarriage imaging systems typically include multiple cameras arranged side-by-side in the width direction of the vehicle so that images are taken as the vehicle moves over the cameras. These undercarriage imaging systems are costly, do not provide accurate imaging data, and/or are difficult to install. They also fail to provide the modularity to accurately capture the required images for larger vehicles, such as trucks and recreational vehicles.

A need exists for an improved undercarriage imaging system that is modular, is easy to install, and provides accurate image data.

### SUMMARY

The various inventions within this provisional application include at least the following devices/systems (as well as combinations of the following devices/systems):

According to one embodiment, an undercarriage imaging system for a vehicle includes a plurality of interlocking trays that are in alignment along a length dimension of the of the plurality of interlocking trays. Each of the plurality of interlocking trays includes a top translucent panel; one or more cameras for taking images of an undercarriage of the vehicle through the top translucent panel; one or more lighting sources for illuminating the undercarriage; and angled side surfaces adjacent to the top translucent panel that enclose a subset of the one or more lighting sources. The undercarriage imaging system also includes an electrical raceway interlocked to at least one of the plurality of interlocking trays. The electrical raceway allows for cables or wiring to exit the plurality of interlocking trays at an angle relative to the length dimension. A first camera within a first one of the interlocking trays is spaced from a second camera within the first one of the interlocking trays by a distance that is approximately equal to the distance between the first camera and a third camera within an adjacent one of the interlocking trays.

According to another embodiment, an undercarriage imaging system for a vehicle includes a housing having angled sidewalls to allow the vehicle to drive over the undercarriage imaging system; a plurality of cameras within the housing for acquiring image data of an undercarriage of the vehicle; a plurality of lighting sources within the housing for illuminating the undercarriage; and a microphone within the housing for recording audio data of the vehicle. The undercarriage imaging system also includes a processor within the housing. The processor is communicatively coupled to the plurality of cameras, the plurality of lighting sources, and the microphone. The processor is configured to process the image data and the audio data and transmit the image data and the audio data to a user device. The undercarriage imaging system further includes a translucent panel covering a top surface of the housing such that the plurality of cameras, the plurality of lighting sources, the microphone, and the processor are enclosed by the translucent panel and the housing. The undercarriage imaging system also includes an electrical raceway coupled to the housing and allowing for cables or wiring to exit the housing.

According to yet another embodiment, a method of imaging an undercarriage of a vehicle includes providing an undercarriage imaging system. The undercarriage imaging system includes a housing enclosing a plurality of cameras, a plurality of lighting sources, a microphone, and a processor. The processor is communicatively coupled to the plurality of cameras, the plurality of lighting sources, and the microphone. The method further includes determining, via the processor, whether a first vehicle is above the undercarriage imaging system. After determining that the first vehicle is above the undercarriage imaging system, the processor activates the plurality of cameras, the plurality of lighting sources, and the microphone. The method also includes acquiring, via the plurality of cameras and the microphone, first image data and first audio data, respectively, of the first vehicle; and determining, via the processor, whether the first vehicle is no longer above the undercarriage imaging system. After determining that the first vehicle is no longer above the undercarriage imaging system, the processor deactivates the plurality of cameras, the plurality of lighting sources, and the microphone. The method further includes determining, via the processor, whether a second vehicle is above the undercarriage imaging system. After determining that the second vehicle is above the undercarriage imaging system the processor activates the plurality of cameras, the plurality of lighting sources, and the microphone. The method also includes acquiring, via the plurality of cameras and the microphone, second image data and second audio data, respectively, of the second vehicle; and determining, via the processor, whether the second vehicle is no longer above the undercarriage imaging system. After determining that the second vehicle is no longer above the undercarriage imaging system, the processor deactivates the plurality of cameras, the plurality of lighting sources, and the microphone.

According to some embodiments, an undercarriage imaging system according to FIGS. 1-4 include one or more of the features/characteristics described relative to FIG. 1-4.

According to another embodiment, an undercarriage imaging system for a vehicle includes a plurality of interlocking trays. Each of the plurality of interlocking trays includes one or more cameras for taking images of an undercarriage of the vehicle.

According to yet another embodiment, an undercarriage imaging system for a vehicle includes a plurality of cameras spaced apart from each other and aligned along a length of the vehicle generally at a center of the vehicle.

According to another embodiment, a modular imaging system for a vehicle includes a plurality of modular imaging trays. The plurality of modular imaging trays include a first end and a second end opposite the first end. The first end of one of the plurality of modular imaging trays is connectable to a second end of an adjacent one of the plurality of modular imaging trays. Each of the plurality of modular imaging trays include a top panel; one or more cameras for taking images of a vehicle through the top panel; one or more lighting sources for illuminating the vehicle; at least one angled side surface adjacent to the top panel that encloses a subset of the one or more lighting sources and transmits light from the subset of the one or more lighting sources toward the vehicle; a projection on the first end of the modular imaging tray; and a recess on a second end of the modular imaging tray. The recess is shaped to receive the projection of the adjacent one of the plurality of modular imaging trays for connecting the adjacent one of the plurality of modular imaging trays.

According to yet another embodiment, a modular imaging system for a vehicle includes a modular imaging tray and a modular light tray. The modular imaging tray includes one or more cameras for taking images of a vehicle; a light controller; a first connecting feature on a first end of the modular imaging tray; and a second connecting feature on a second end of the modular imagining tray. The second end is on an opposing side to the first end of the modular imaging tray. The modular light tray includes at least one light panel configured to be controlled by the light controller; and a light-tray connecting feature for connecting with at least one of the first and second connecting features of the modular imaging tray.

According to yet another embodiment, a modular imaging system for a vehicle includes a modular imaging tray and a modular battery tray. The modular imaging tray includes one or more cameras for taking images of a vehicle; one or more lighting sources for illuminating the vehicle; a first connecting feature on a first end of the modular imaging tray; and a second connecting feature on a second end of the modular imagining tray. The second end is on an opposing side to the first end of the modular imaging tray. The modular battery tray includes a battery configured to power the one or more cameras and the one or more lighting sources; and a battery-tray connecting feature for connecting with at least one of the first and second connecting features of the modular imaging tray.

According to some embodiments, a method of imaging a vehicle with a modular imaging system includes providing the modular imaging system. The modular imaging system includes a modular imaging tray. The modular imaging tray includes one or more cameras for taking images of a vehicle; a microphone; angled side surfaces extending lengthwise along the modular imaging tray that enclose one or more lighting sources; and a processor communicatively coupled to the one or more cameras, the one or more lighting sources, and the microphone. The method also includes determining, via the processor, whether a first vehicle is within a range of the one or more cameras; and after determining that the first vehicle is within the range, activating, via the processor, the one or more cameras, the microphone, and the one or more lighting sources. The method further includes acquiring, via the one or more cameras and the microphone, first image data and first audio data, respectively, of the first vehicle; determining, via the processor, whether the first vehicle is no longer within the range; after determining that the first vehicle is no longer within the range, deactivating, via the processor, the one or more cameras, the microphone, and the one or more lighting sources; and determining, via the processor, whether a second vehicle is within the range. The method also includes, after determining that the second vehicle is within the range, activating, via the processor, the one or more cameras, the microphone, and the one or more lighting sources; acquiring, via the one or more cameras and the microphone, second image data and second audio data, respectively, of the second vehicle; determining, via the processor, whether the second vehicle is no longer within the range; and after determining that the second vehicle is no longer within the range, deactivating, via the processor, the one or more cameras, the microphone, and the one or more lighting sources. According to further embodiments, the method also includes receiving, via the processor, a user input from a user, the user input indicative of whether the first vehicle is within the range. According to alternative embodiments, the method further includes receiving, via the processor, a signal from a sensor of the modular imaging system, the signal indicative of a proximity of the first vehicle to the modular imaging system. In further embodiments, the sensor is a first camera of the one or more cameras. According to yet another embodiment, the method further includes moving the modular imaging system, via wheels or tank treads on which the modular imaging system is mounted, underneath the first vehicle. According to another embodiment, the method further includes transmitting, via the processor, the first image data to a user device; and displaying, on a display of the user device, the first image data of the first vehicle.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

Disclosed herein are embodiments of systems, apparatuses, and methods pertaining to an imaging system for capturing images of vehicles of various sizes. This description includes drawings, wherein:

FIG. 1 illustrates an undercarriage imaging system that is coupled to an operator control module.

FIG. 2A illustrates one of the two modular imaging trays of the undercarriage imaging system of FIG. 1.

FIG. 2B illustrates another of the two modular imaging trays of the undercarriage imaging system of FIG. 1.

FIG. 3A is a top view of the modular imaging tray of the undercarriage imaging system of FIGS. 1–2.

FIG. 3B is a perspective view of the modular imaging tray of the undercarriage imaging system of FIGS. 1–2.

FIG. 3C is the male-side end view of the modular imaging tray of the undercarriage imaging system of FIGS. 1–2.

FIG. 3D is the female-side end view of the modular imaging tray of the undercarriage imaging system of FIGS. 1–2.

FIG. 4 illustrates the multiple pieces of the modular imaging tray.

FIG. 5 illustrates the undercarriage imaging system in which ten modular imaging trays are interlocked such that the undercarriage imaging system can be used for vehicles that are larger than a standard car.

FIG. 6 illustrates an undercarriage imaging system, according to an alternative embodiment.

FIG. 7 is a perspective view of the undercarriage imaging system of FIG. 6 coupled to a low-profile electrical raceway.

FIG. 8. is a perspective view of the undercarriage imaging system of FIGS. 6–7 with the light panels removed.

FIG. 9A is a side view of the undercarriage imaging system of FIGS. 6–8 beginning to image an undercarriage of a vehicle

FIG. 9B is a side view of the undercarriage imaging system of FIGS. 6–8 imaging an undercarriage of a vehicle.

FIGS. 10A illustrates a display showing the image data acquired by the undercarriage imaging system of FIGS. 6–9B at a first time.

FIGS. 10B illustrates a display showing the image data acquired by the undercarriage imaging system of FIGS. 6–9B at a second time.

FIGS. 10C illustrates a display showing the image data acquired by the undercarriage imaging system of FIGS. 6–9B at a third time.

FIG. 11 is a top view of a modular imaging system including a modular imaging tray connected to two modular light trays, according to another alternative embodiment.

FIG. 12 is an interior top view of the modular imaging system of FIG. 11.

FIG. 13 is a perspective view of a modular battery tray connected to a modular light tray.

FIG. 14 is a perspective interior view of the modular battery tray of FIG. 13.

FIG. 15A is a perspective view of a modular imaging system including a modular imaging tray connected to two modular battery trays, which are connected to two modular light trays.

FIG. 15B is a perspective view of the modular imaging system of FIG. 15A, with the trays disconnected and spaced apart from each other.

FIG. 16 is a perspective view of the modular imaging system of FIGS. 11–12 on wheels.

FIG. 17 is a perspective view of a modular imaging system, according to yet another embodiment.

While the invention is susceptible to various modifications and alternative forms, specific embodiments will be shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

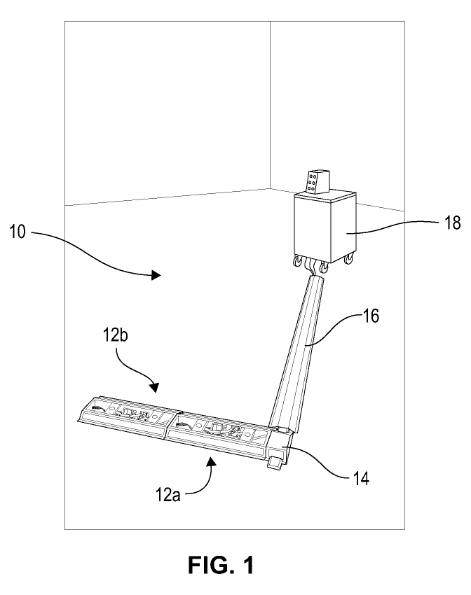

FIG. 1 illustrates an undercarriage imaging system 10 that is comprised of modular imaging trays 12 and an electrical connector segment 14. In the illustrated embodiment of FIG. 1, only two modular imaging trays 12a, 12b are shown, although an undercarriage imaging system 10 may have between twenty to thirty (or more) imaging trays 12. The electrical connector segment 14 is connected to the modular imaging tray 12a and provides electrical power and cabling to both trays 12a and 12b. The electrical wires and cabling are contained under or within a low-profile electrical raceway 16 and are connected to an operator station 18. The low-profile electrical raceway 16 is typically a trapezoidal cross-sections shape to permit tires from the vehicle to pass over the raceway 16.

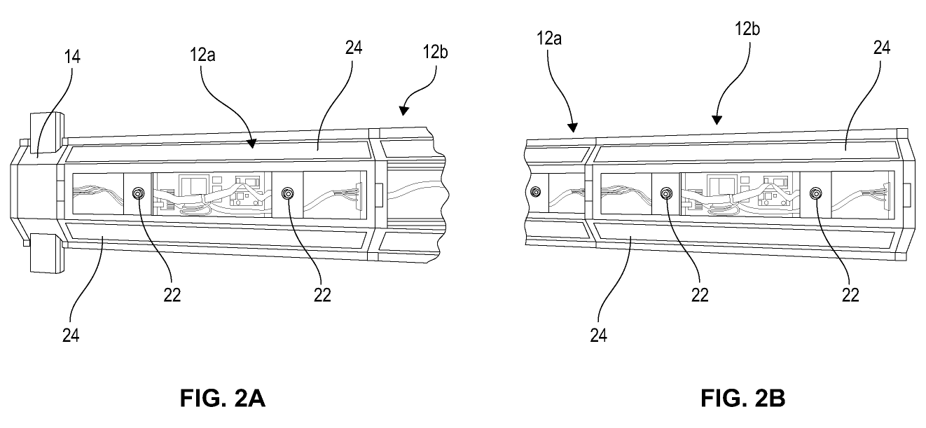

FIGS. 2A and 2B are close-up views of the modular imaging trays 12a, 12b and the electrical connector segment 14. Each of the trays 12a and 12bcontains two cameras 22 that are positioned in a way that the cameras 22 in both trays 12a and 12b are spaced apart by approximately the same distance. As such, in the illustrated embodiment, when two cameras 22 are in each tray 12, each camera 22 is positioned from the corresponding end of the tray by a distance equal to approximately a third (1/3) of the overall length of the tray 12. As such, regardless of the number of trays 12 in the undercarriage imaging system 10, each camera 22 is spaced apart from the adjacent camera 22 by approximately the same distance.

In addition to the two cameras 12, the center cavity of each tray 12 contains one or more micro-computers, electronic components (e.g., relays, quick disconnects, etc.), LED strips, power lines, and cabling for control signals and data transfer to/from the operator station 18, which are shown in FIGS. 2A–2B. Alternatively, all electronic components may reside on a single circuit board. The LED strips are located below the translucent angled sidewalls 24 to illuminate the entire undercarriage of the vehicle. The center cavity is protected at its upper surface of the tray 12 by a rectangular translucent structure, such as a clear acrylic panel which rests against an underlying gasket. The acrylic panel and the cork gasket can be seen in FIG. 2A but have been removed in FIG. 2B for the purposes of better illustrating the underlying cameras 22 and corresponding electrical components. The cameras 22 and any associated lenses face upwardly with the field of view through the clear acrylic protective panel. The cameras 22 preferably provide a 180 degree field of view to capture the entire undercarriage width of the vehicle.

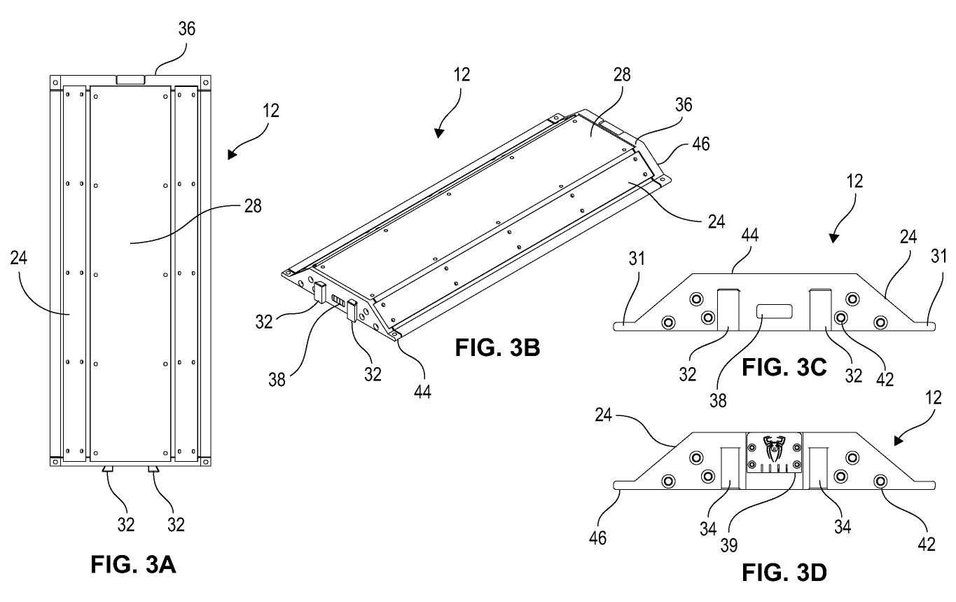

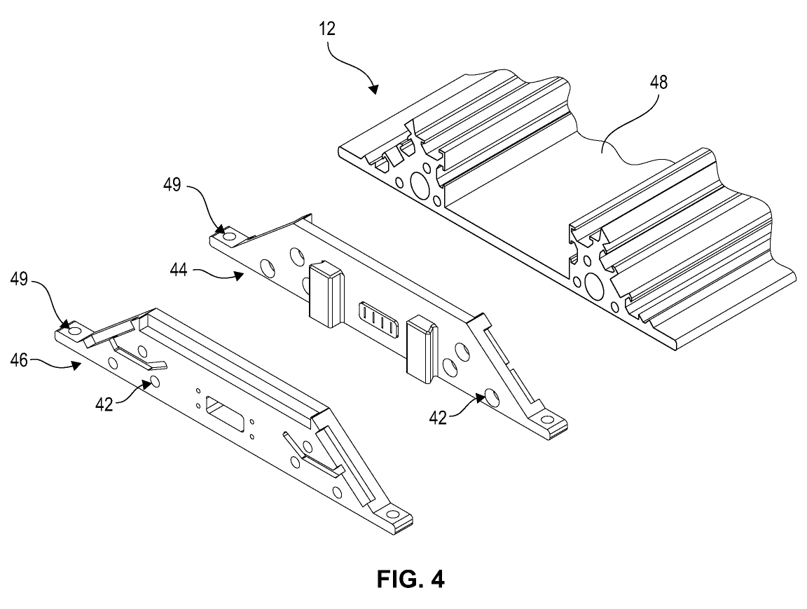

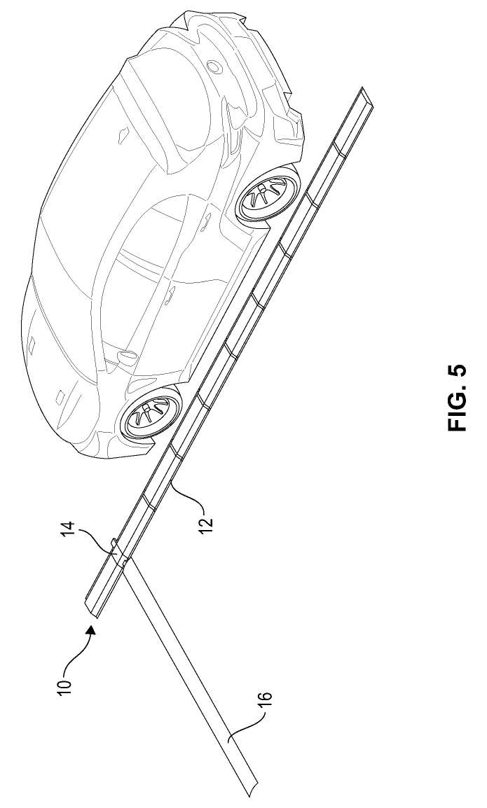

FIGS. 3A–3D illustrates the modular imaging tray 12 in a top view, perspective view, male-end view and female-end view, respectively. A rectangular clear panel 28 is shown in FIGS. 3A and 3B between the pair of the translucent angled sidewalls 24. The rectangular clear panel 28 is a preferably a clear acrylic, while the translucent angled sidewalls 24 are preferably white opaque acrylic panels for disbursing light to the undercarriage. The bottom of the modular imaging tray 12 is completely flat and is designed to be placed on the ground or floor. Flanges 31 (FIG. 3C) are located adjacent to the angled sidewalls 24 to allow for anchoring or mounting to the floor via fasteners, if desired. The angled sidewalls 24 are preferably at about a 45 degree angle relative to the floor.

The male end of the modular imaging tray 12 includes two projections 32 that extend away from the modular imaging tray 12. The female end of the modular imaging tray 12 includes two recesses 34 that extend into the modular imaging tray 12. A flange 36 is located on the female end of the modular imaging tray 12 above the two recesses 34. To interlock two adjacent modular imaging trays 12, the female end of the first modular imaging tray 12 is placed over the male end of the second modular imaging tray 12 such that the two projections 32 fit within the two recesses 32. The female end of the first modular imaging tray 12 is then moved downwardly onto the male end of the second modular imaging tray 12 until the flange 36 on the female end rests flush against the upper end of the male end of the second imaging tray 12. The interlocking projections 32 and recesses 34 have corresponding shapes that form undercuts to provide the interlocking functionality so that the adjacent trays 12 are locked together and cannot be pulled apart. As shown in FIGS. 3A and 3B, the projections 32 have an angled side walls that cause the tips of the projections 32 to be wider than the bases of the projections 32, creating an undercut than mates within similarly shaped geometric features in the recesses 34. In an alternative embodiment, adjacent trays 12 may be locked together via fasteners, such as clips, screws, or latches.

To provide channels for electrical wires and cabling between interlocked modular imaging trays 12, the male end and the female end have openings 38. The passage of the electrical wires and cabling through the openings 38 can be seen better in FIGS. 2A and 2B. Because the undercarriage imaging system 10 is comprised of multiple modular imaging trays 12, there is always an exposed end on the last modular imaging tray 12 with an opening 38 through which no wire or cabling is passed. To seal the exposed opening 38 of the last modular imaging tray 12, a plate 39 is fastened to the end surface of the last modular imaging tray 12, as shown in FIG. 3D.

To provide an interlocking effect to the electrical connector segment 14 shown in FIGS. 1–2, the electrical connector segment 14 also includes similar recesses and projections, allowing the electrical connector segment 14 to mate with the modular imaging trays 12 within the undercarriage imaging system 10. The electrical connector segment 14 also includes openings at its ends to receiving the electrical wires and cabling, which are bent within the electrical connector segment 14 and then exit through a side opening in the electrical connector segment 14 before entering the electrical raceway 16 shown in in FIG. 1.

In one exemplary embodiment, each modular imaging tray 12 has dimensions of less than about 48 inches, such as about 36 inches. In one embodiment, each modular imaging tray 12 is about 24 inches in length, about 10 inches in width (e.g., 9 ¾ inches), and about 2 inches in height (1 3/4" inches). Each modular imaging tray 12 is made of extruded aluminum or other hard metal that protects the internal electronics and cameras 22 (e.g., if accidentally driven over by a tire of a vehicle). Because the modular imaging trays 12 are relatively small and can be manually handled, the undercarriage imaging system 10 is a portable solution, allowing it to be moved within a facility or between facilities. It is also a modular solution in that it can be reconfigured with a different number of trays 12 or with a different location for the electrical connector segment 14 within the plurality of trays 12. FIGS. 3C and 3D also show six openings 42 on each end of the modular imaging trays 12 that are used for receiving fasteners to hold the modular tray 12 together when it is made of multiple pieces.

FIG. 4 illustrates one embodiment of the modular imaging tray 12 that is made of a multiple pieces. A male end plate 44 and a female end plate 46 are held to the main tray body 48 via fasteners (not shown) that extend through the six openings 42 in the male end plate 44 and the six openings 42 in the female end plate 46. The male end plate 44 and the female end plate 46 also include mounting openings 49 for mounting the modular imaging tray 12 to the floor. FIG. 4 also shows the longitudinal channels on each side of the main tray body 48 for housing the LED-strips that provide illumination of the undercarriage.

FIG. 5 illustrates the undercarriage imaging system 10 with a small-to-midsize car next to it for the purposes of showing the scale of the undercarriage imaging system 10. In use, the car would have its driver-side two tires on one side of the modular imaging trays 12 and its passenger-side two tires on the other side of the modular imaging trays 12, such that the trays 12 are generally under a center line of the car. Thus, the image of the undercarriage is captured by an undercarriage imaging system 10 that extends along the length of the vehicle and uses a series of 180 degree field-of-view cameras. With ten interlocking modular imaging trays 12 having 20 cameras, the undercarriage imaging system 10 can capture the images of the entire undercarriage of the largest of consumer cars/trucks, such as Chevrolet Suburban or a Ford Expedition XL. If the undercarriage imaging system 10 was to be used on larger vehicles (e.g., buses or recreational vehicles),additional modular imaging trays 12 could be added to account for the additional length of the larger vehicle. For example, the undercarriage imaging system 10 may have between thirty and fifty modular trays 12 for imaging a bus or a tractor trailer.

In a further embodiment, in addition to the modular imaging trays 12, the undercarriage imaging system 10 includes an end imaging tray that is stationed at each end of the first and last modular imaging trays 12 to capture the images of the front and rear bumpers of the vehicle. In this embodiment, the end imaging tray may have cameras angled more toward the vehicle, as opposed to the cameras 22 in the modular imaging trays 12 that are aimed in a substantially upward direction.

In yet a further embodiment, one or more of modular imaging trays 12 may include a microphone to capture audio of the vehicle. This will allow the user to hear the vehicle under different parts of the vehicle as the user is reviewing the undercarriage images. Additional sensors may be equipped in the modular imaging trays 12 as well, such as thermal sensors and infrared sensors.

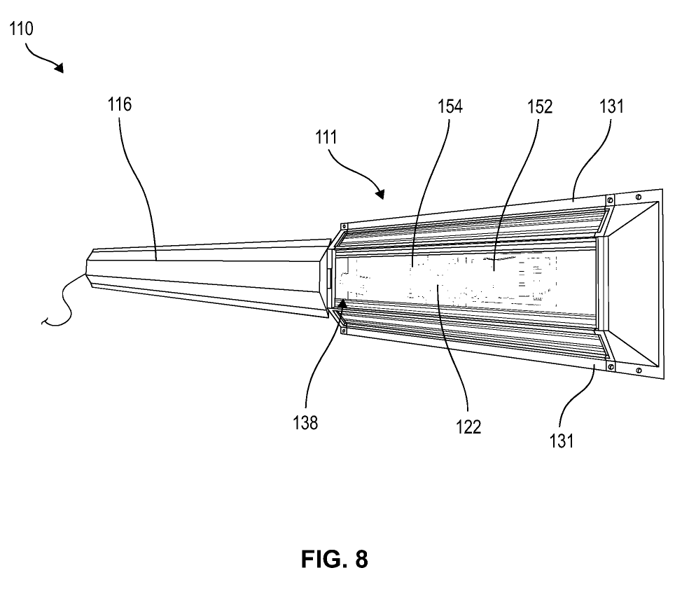

The undercarriage imaging system 10 may be used alone, or with an imaging system that captures exterior images of the overall vehicle, such as the various imaging systems shown in U.S. Patent No. 12,026,769, which is commonly owned and herein incorporated by reference in its entirety. The undercarriage imaging system 10 is particularly useful when used in conjunction with the imaging system in FIGS. 8–11 of U.S. Patent No. 12,026,769 such that the undercarriage imaging system 10 is located below the undercarriage and the imaging system in FIGS. 8–11 of U.S. Patent No. 12,026,769 is located over the vehicle, allowing for images of the undercarriage to be taken at the same time as images of the exterior of the vehicle.

In operation, a driver at the dealership, auction or other facility pulls the vehicle over the top of the of the interconnected imaging trays 12 and stops the vehicle. The driver drives over the top of the trays 12 long ways so that the trays 12 are aligned along the center of the undercarriage of the vehicle. Ideally the vehicle tires never drive on top of the trays 12, but only over the electrical raceway 16. Next, the driver may or may not exit the vehicle based on the configuration of the system. The vehicle is identified (e.g., a scan of the VIN plate, stock label, work order, repair order, etc.) with a phone camera, a fixed position camera, or laser hand-scanner. Alternatively, the identification of the vehicle is automatically taken through an automatic imaging system that captures the VIN from a distance above the vehicle. The images are captured and uploaded to a central server (e.g., the Black Widow Imaging server) for processing. The driver then pulls away from the undercarriage imaging system 10.

The undercarriage imaging system 10 is a solution for capturing images on the underside (undercarriage) of a movable vehicle or asset such as a car, truck, boat, RV, trailer, bus, semi-tractor trailer, trailer, tank, heavy duty equipment, etc. These images can be used for inspection of the vehicle without having to place the vehicle on a lift or risk the life of a human by having them go under a vehicle to inspect. The undercarriage imaging system 10 produces 10 to 20 high resolution virtual 180 degree images to allow the user to pan and zoom on each photograph. The images of the undercarriage can be used by an inspector (human or machine) or prospective buyer for assessment of the condition of the vehicle. The images can be syndicated to the customer websites or internal systems as desired. The images can be used with virtual reality headsets to create an experience like the user or operator is really standing under the vehicle. This system may be paired with the standard external imaging systems such that the images of the side and top of the vehicle can be captured at the same time as the undercarriage of the vehicle. Alternatively, the undercarriage solution may be controlled separately or independently using a mobile app.

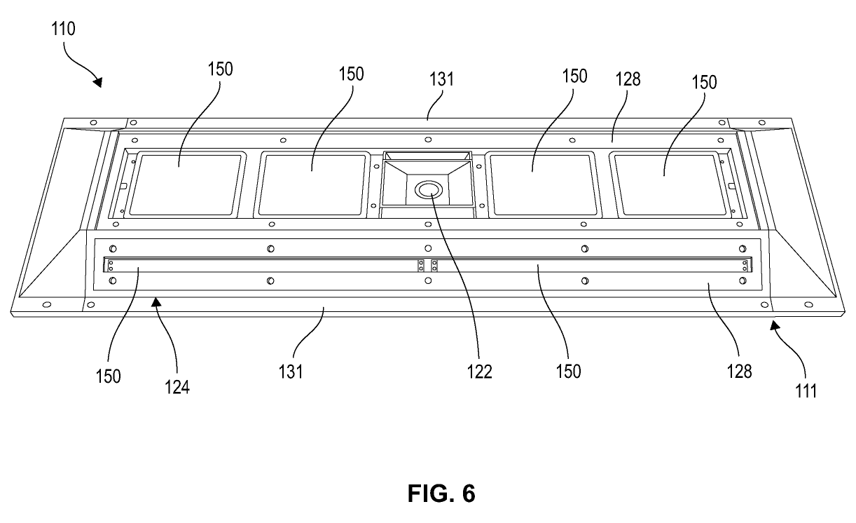

FIG. 6 illustrates an undercarriage imaging system 110, according to an alternative embodiment. A housing 111 of the undercarriage imaging system 110 is of a trapezoidal cross-sectional shape and is of a short enough height to permit vehicles to easily drive over it without causing damage to the undercarriage of the vehicles. The undercarriage imaging system 110 is fabricated from metal, plastic, and/or other material(s) capable of withstanding a vehicle if its tires were to drive over the top of it. The edges of the undercarriage imaging system 110 include a flange 131 that is flush with a ground surface when the undercarriage imaging system 110 is in use. In some embodiments, the flange 131 includes openings, such as threaded openings, such that fasteners can be inserted therethrough and into a floor or ground surface to prevent the undercarriage imaging system 110 from sliding along a floor or ground surface.

The undercarriage imaging system 110 includes a camera 122 to image undercarriages of vehicles that drive over the undercarriage imaging system 110. The camera 122 provides a 180 degree field of view to capture the entire undercarriage width of the vehicle. Although only one camera 122 is shown in FIG. 6, the undercarriage imaging system 110 can include two, three, four, five, or more cameras 122 spaced apart along the length of the undercarriage imaging system 110. The camera 122 is capable of capturing images, videos, or both of the underside of vehicles or other large objects that pass over the undercarriage imaging system 110.

Four light panels 150 are positioned along the length of the upper surface of the undercarriage imaging system 110 to illuminate the undercarriage of the vehicle being imaged. There are also two light panels 150 within a translucent angled sidewall 124 of the undercarriage imaging system 110. Although light panels 150 are shown within the translucent angled sidewall 124, in some embodiments, there are no light panels within the translucent angled sidewall 124. In some embodiments, one, two, three, four, five, seven, or more total light panels 150 are included. According to some embodiments, the light panels 150 include one or more LEDs. In some embodiments, the light panels 150 are communicatively coupled to a lighting controller that controls the operation of the light panels 150. For example, the lighting controller can turn the light panels 150 on and off, as well as control the amount, type, and/or color of light emitted from the light panels 150. In further embodiments, the lighting controller includes a sensor that detects when an object is above it, such that the light panels 150 are turned on when a vehicle is passing over the undercarriage imaging system 110 and are turned off when a vehicle is not passing over.

A rectangular clear panel 128 covers the uppermost surface of the undercarriage imaging system 110 to protect the camera 122, light panels 150, and other internal components from being damaged when vehicles drive over the undercarriage imaging system 110. There is also a rectangular clear panel 128 on the outer surface of the translucent angled sidewalls 124 to protect the light panels 150 of the translucent angled sidewalls 124 from being damaged. In some embodiments, the rectangular clear panels 128 are made of acrylic, polycarbonate, and/or other transparent and/or scratch-resistant materials. In some embodiments, the rectangular clear panels of the translucent angled sidewalls 124 and the uppermost surface of the undercarriage imaging system 110 are made of the same material.

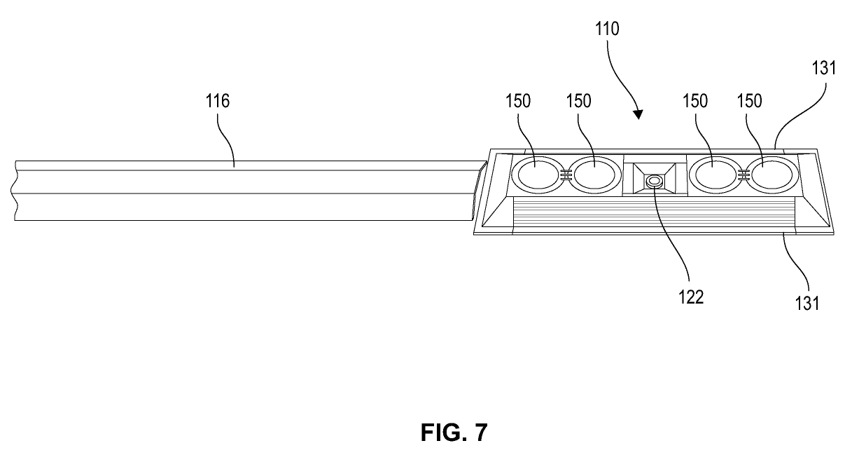

As can be seen best in FIG. 7, the undercarriage imaging system 110 is connected to a low-profile electrical raceway 116, which contains electrical wires and cabling to deliver power to and/or transmit information to and from the undercarriage imaging system 110. The low-profile electrical raceway 116 is typically a trapezoidal cross-sectional shape to permit tires from the vehicle to pass over the raceway 116.

FIG. 8. is a perspective view of the undercarriage imaging system 110 with the light panels 150, rectangular clear panel 128, and translucent angled sidewalls 124 removed so that the internal components can be seen. As shown in FIG. 8, there is an enclosure within the housing 111 of the undercarriage imaging system 110 that encloses the camera 122, a processor 152, a microphone 154, and the electrical wires and cabling connected to the same. In some embodiments, the enclosure includes gasketing to prevent water intrusion that could damage the camera 122, the processor 152, the microphone 154, and/or the electrical wires and cabling connected to the same.

The electrical wires and cabling connect to the low-profile electrical raceway 116 by passing through an opening 138 at an end of the undercarriage imaging system 110. However, in some embodiments, power cables are not needed to provide power to the undercarriage imaging system 110 since it is instead powered by a battery within the enclosure. In some embodiments, the enclosure is shaped and configured to interlock or daisy chain with one or more additional enclosures. In further embodiments, the enclosures are shaped and designed to allow electrical power to pass between the enclosures. For example, and according to some embodiments, the enclosures have end plates that include electrical connectors to allow power to transmit across multiple enclosures. In some embodiments, the enclosures interlock or daisy chain to each other. For example, and in some embodiments, the enclosures interlock through the use of male and female end plates, such as those shown and described with respect to FIG. 4.

The microphone 154 is used to capture audio of the vehicle as it passes over the undercarriage imaging system 110. For example, the microphone 154 may be used to capture the sounds of the vehicle’s engine and/or exhaust system. The processor 152 processes the image, video, and audio data captured by the camera 122 and the microphone 154. For example, and in some embodiments, the processor 152 transmits the data via WiFi and/or Bluetooth to a user device. In some embodiments, the processor analyzes the video feed of the camera 122 to determine whether a vehicle is being driven over the undercarriage imaging system 110. In some embodiments, the processor utilizes artificial intelligence to differentiate between vehicles and other objects, or between different types of vehicles. In some embodiments, the processor 152 activates the camera to capture image and/or video data. In some embodiments, the processor 152 activates and/or deactivates the light panels 150.

As can be seen in FIGS. 6–8, the housing 111 of the undercarriage imaging system 110 is a tray like the tray 12 in FIGS. 1–5. It can have two end pieces that attach to the main part of the housing 111, one of which connects to the raceway 116 through male projections and female recesses, like projections 32 and recesses 34 in FIGS. 3A–3D. Although only one housing 111 is shown, there could be multiple housings 111 in the undercarriage imaging system 110 connected via male projections and female recesses. In that sense, the tray-like housing 111 of the undercarriage imaging system 110 is modular, like the trays 12 of FIGS. 1–5.

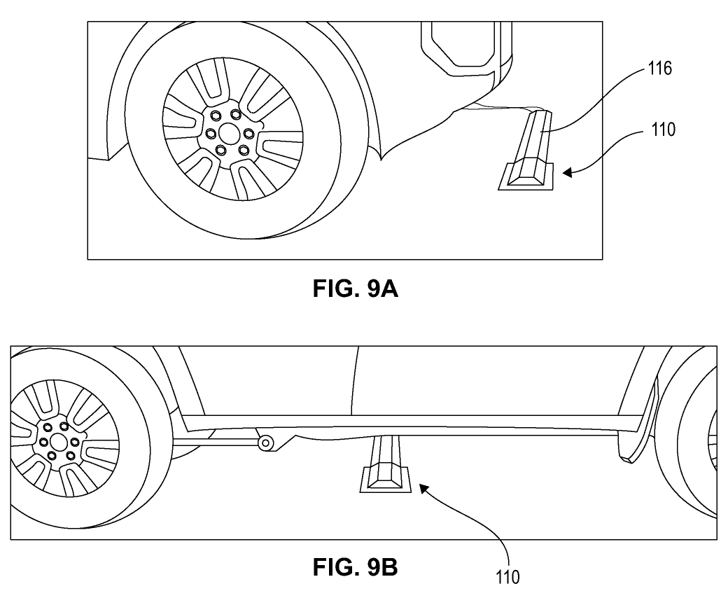

FIGS. 9A–9B are side views of the undercarriage imaging system 110 of FIGS. 6–8 imaging an undercarriage of a vehicle. As shown in FIG. 9A, the undercarriage imaging system 110 is activated when a vehicle begins to pass over it after detection by a sensor within the undercarriage imaging system 110. For example, and in some embodiments, the sensor is a proximity sensor, such as an inductive, capacitive, ultrasonic, optical, or magnetic proximity sensor. Once activated, the light panels 150 of the undercarriage imaging system 110 begin to illuminate the undercarriage, the camera 122 begins to capture image and/or video data, and the microphone 154 captures audio data of the vehicle. The undercarriage imaging system 110 continues to capture data as the vehicle passes over it. In some embodiments, if the vehicle stops moving while above the undercarriage imaging system 110, such as in the position shown in FIG. 9B, the processor 152 will deactivate the camera 122 and/or the microphone 154 so that video and/or audio data is not being captured when the vehicle is immobile.

While the undercarriage imaging system 110 is activated, the processor 152 analyzes the video data to determine whether the vehicle or object being recorded is still above the system 110. Once the processor determines that the vehicle or object being recorded is no longer above the system 110, the processor 152 deactivates the light panels 150 and/or the microphone 154. In some embodiments, the processor 152 causes the camera 122 to stop recording video data once the vehicle or object being recorded is no longer above the system 110. In some embodiments, the processor 152 then continues to review the video and/or image data acquired by the camera 122 to determine whether another vehicle or object is passing over the system 110. In some embodiments, the processor 152 receives an input from a sensor, such as a proximity sensor, to determine whether another vehicle or object is passing over the undercarriage imaging system 110. In some embodiments, the processor 152 receives an input from a user that indicates that another vehicle or object is passing over the undercarriage imaging system 110. After each vehicle or object passes over the system 110, the processor 152 transmits the image, video, and/or audio data to a user device for further processing, viewing, and/or storage.

Although not shown in FIGS. 6–9B, in some embodiments, the undercarriage imaging system 110 is mounted on tank treads and/or wheels so that the undercarriage imaging system 110 is mobile. In such an embodiment, the undercarriage imaging system 110 is placed in front of a vehicle or object to be imaged and the undercarriage imaging system 110 moves under the vehicle or object to capture image, video, and/or audio data of the undercarriage of the vehicle or object. In some embodiments of the mobile undercarriage imaging system 110, the undercarriage imaging system 110 moves under the vehicle upon a user selecting a button on a user device, such as selecting a button in an application on a mobile phone. In further embodiments of the mobile undercarriage imaging system 110, the undercarriage imaging system 110 stops moving upon the user selecting a button on the user device. In some embodiments of the mobile undercarriage imaging system 110, the undercarriage imaging system 110 moves under the center of the width or length of the vehicle. In some such embodiments, the undercarriage imaging system 110 utilizes an AI model to keep its path of travel near or at the center of the width or length of the vehicle. In some such embodiments, the AI model uses the amount of light received by the undercarriage imaging system 110 from the sides of the object being imaged as an input.

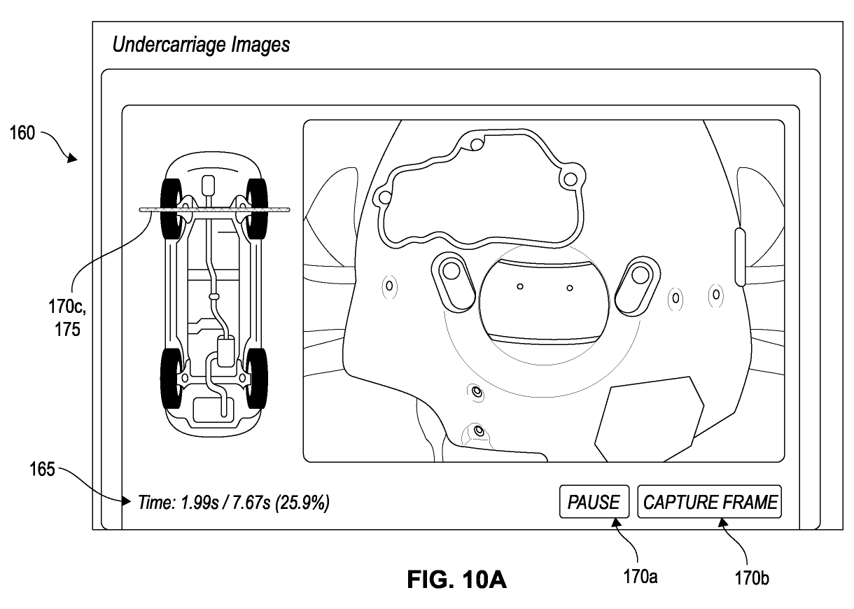

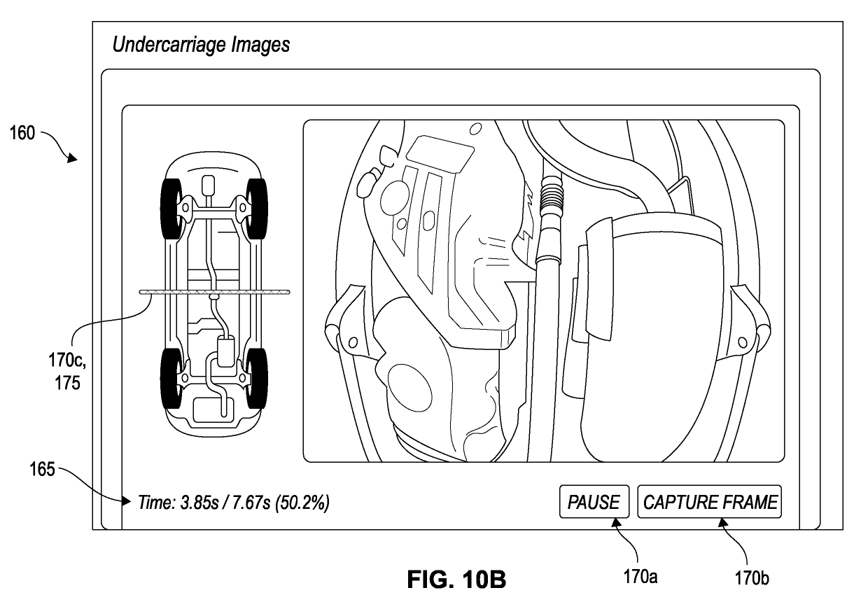

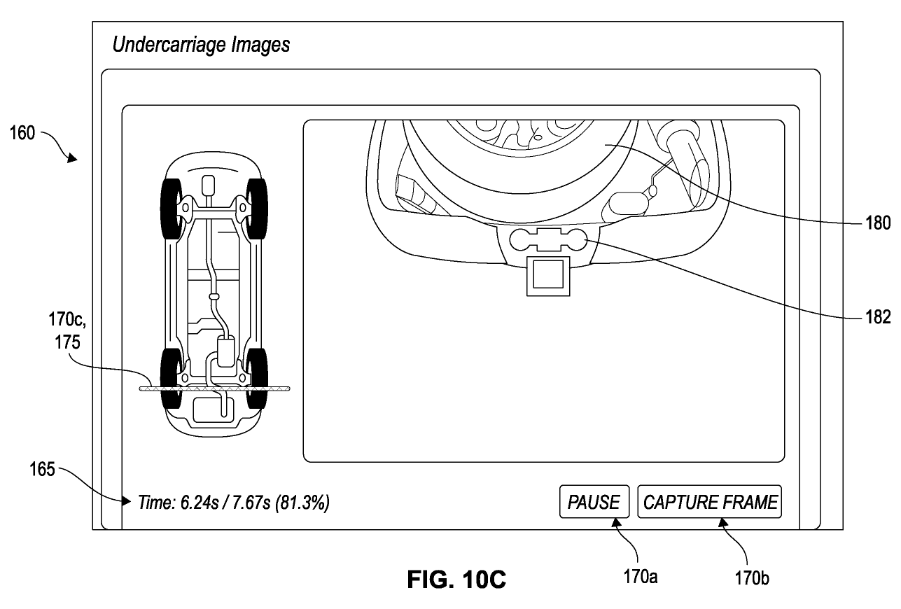

FIGS. 10A–10C show three chronological frames of the video of the vehicle that was recorded by the undercarriage imaging system 110 on a display 160. The relevant time stamps 165 of the video are shown on the lower left-hand corner of the display 160. The display 160 may include user-selectable elements 170, such as a “pause” button 170a and a “capture frame” button 170b on the lower right-hand corner of the display 160. When the “pause” button 170a is activated by the user, the video is paused on the display 160 and when the “capture frame” button is pressed, an image of the current frame of the video being displayed is captured. Other user-selectable elements 170 may be provided that allow the user to control the playback speed of the video, to zoom-in on parts of the image, or to turn up the volume of the sound recording.

The video of the undercarriage of the vehicle is shown on the right side of the display 160. In some embodiments, the captured audio data plays when the video plays. In some embodiments, the video loops automatically. On the left side of the display 160, an illustration of a vehicle is shown with a red horizontal line 175 over it. The red line 175 indicates which part of the undercarriage of the vehicle is currently being shown on the display 160. The red line is another user-selectable element 170c that is movable by a user of the display 160 so that the user can select the part of the undercarriage of the vehicle the user wishes to see on the display 160.

As shown in FIG. 10C, many vehicles carry a spare tire 180 underneath the vehicle. The undercarriage imaging system 110 provides detailed images of the spare tire 180 to determine whether the spare tire 180 is a full-size spare tire or a mini spare tire, the overall condition of the spare tire 180 based on its treads, and the condition of the spare tire 180 relative to the four tires on the vehicle. This spare-tire information can also be displayed on the display 160, such as in response to the user activating a spare-tire user-selectable element.

Similarly, the many vehicles have a mounted hitch system that allows the vehicle to pull trailers of various sizes. The undercarriage imaging system 110 provides detailed images of the mounted hitch system 182 to determine whether it is an OEM hitch system, an after-market hitch system, the towing capacity of the hitch system, and the condition of the hitch system (e.g., conditions of the hitch structure and the fasteners attaching the hitch system to the vehicle’s frame). This hitch-system information can also be displayed on the display 160, such as in response to the user activating a hitch-system user-selectable element.

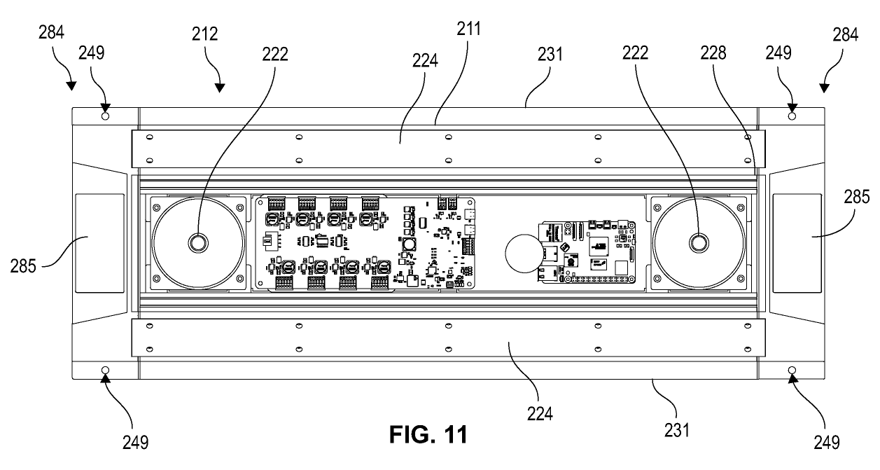

FIG. 11 illustrates a modular imaging system for a vehicle, according to another embodiment, that includes a modular imaging tray 212, and two modular light trays 284 coupled to opposing ends of the modular imaging tray 212. The modular imaging tray 212 includes a housing 211 that receives two cameras 222 for imaging a vehicle driving past the modular imaging tray 212 and the associated electronics. In some embodiments, the cameras 222 have a 180 degree field of view to capture the entire width (if the modular imaging tray 212 is above or below the vehicle) or height (if the modular imaging tray 212 is to the side of the vehicle) of the vehicle. Although only two cameras 222 are shown in FIG. 11, in some embodiments, fewer or more cameras 222 are in the cavity of the modular imaging tray 212; for example, one, three, four, five, six, or more cameras 222. In some embodiments, the cameras 222 are capable of panning, tilting, and/or zooming.

A rectangular clear panel 228 is positioned over the cavity of the modular imaging tray 212 so that the cameras 222 can capture clear images therethrough, as well as protect the components, e.g., cameras 222, in the cavity. In some embodiments, the rectangular clear panel 228 is secured over the cavity of the modular imaging tray 212 such that water is unable to reach the components within the cavity. In some embodiments, the rectangular clear panel 228 comprises acrylic, polycarbonate, aluminum oxynitride, or any other transparent material capable of withstanding the weight of a vehicle driving over it.

The modular imaging tray 212 has angled sidewalls 224 extending along the length of the modular imaging tray 212 on each side of the cavity. The angled sidewalls 224 enclose one or more lights and are preferably translucent to permit light to pass through from the lights within the sidewalls 224. In some embodiments, the translucent angled sidewalls 224 include white opaque acrylic panels for disbursing light to the vehicle.

The modular imaging tray 212 further includes flanges 231 extending lengthwise along the translucent angled sidewalls 224. When the modular imaging tray 212 is positioned on, e.g., a floor, wall, or ceiling surface, the flanges 231 are flush with that surface when the modular imaging tray 212 is in use. In some embodiments, although not shown in FIG. 11, the flanges 231 include openings, such as threaded openings, such that fasteners can be inserted therethrough and into, e.g., a floor, wall, or ceiling surface to prevent the modular imaging tray 212 from sliding along that surface.

As shown in FIG. 11, the modular imaging tray 212 has a modular light tray 284 coupled to each of the two ends of the modular imaging tray 212. The modular light trays 284 also include angled sidewalls 285 that enclose one or more lights therein. The modular light trays 284 are coupled to the modular imaging tray 212 to provide additional illumination of the vehicle being imaged by the cameras 222. The angled sidewalls 285 are preferably translucent to permit light to pass through from the lights within the sidewalls 285. For example, the angled sidewalls 285 include white opaque acrylic panels for disbursing light to the vehicle

The angled sidewalls 224 of the modular imaging tray 212 and the angled sidewalls 285 of the modular light trays 284 are at an angle with the rectangular clear panel 228 to prevent hot spots in the image or video data collected by the cameras 222. In some embodiments, such as when the modular imaging tray 212 is used to capture image or video data of an undercarriage of the vehicle, the angled sidewalls 224 and/or 285 are at a sufficient angle with the rectangular clear panel 228 to illuminate the outer edges of the vehicle being imaged, e.g., to better illuminate the rails and frame of the vehicle. For example, and in some embodiments, the angled sidewalls 224 and/or 285 are at an angle with the rectangular clear panel 228 between about 10 and 90 degrees, about 15 and 75 degrees, about 25 and 65 degrees, about 35 and 55 degrees, about 40 and 50 degrees, or at about a 45 degree angle. In some embodiments, the various angled sidewalls 224 and/or 285 are at different angles to the rectangular clear panel 228 they are adjacent to. In other embodiments, all of the angles are the same.

The modular light trays 284 also include mounting openings 249 through which fasteners can pass through to mount the modular light trays 284 to a floor, wall, or ceiling. Since the modular imaging tray 212 is connected to the modular light trays 284, these mounting openings 249 also assist in keeping the modular imaging trays 212 affixed to the floor, wall, or ceiling. In some embodiments, although not shown in FIG. 11, the mounting openings 249 are threaded such that threaded fasteners can pass therethrough.

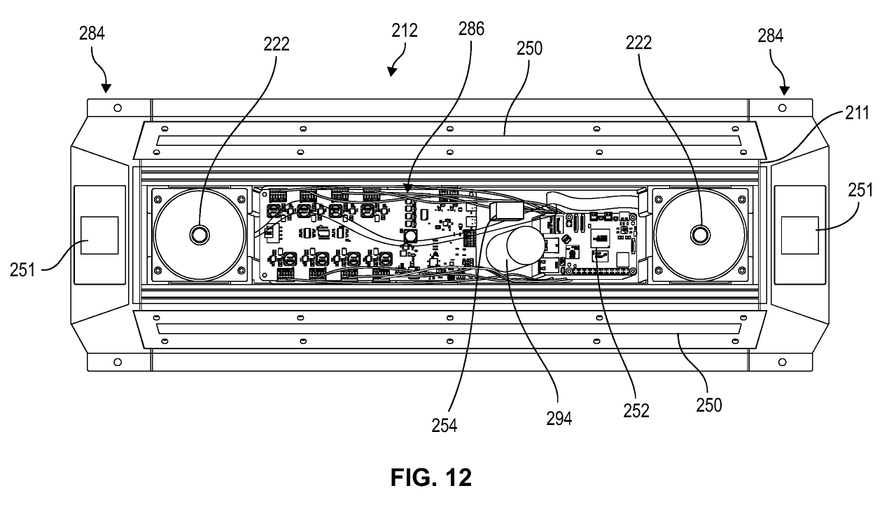

FIG. 12 is an interior top view of the modular imaging system of FIG. 11 in which the panels have been removed to better show the components within the cavities of the angled sidewalls 224 and/or 285 and the central cavity of the modular imaging tray 212. As shown in FIG. 12, there is one light panel 250 in the cavity of each angled sidewall 224 of the modular imaging tray 212 one light panel 251 in the cavity of each angled sidewall 285 of the modular light trays 284. In some embodiments, the angled sidewalls 224 and/or 285 include more than one light panel 250, 251, such as two, three, four, five, six, or more light panels 250, 251. In some embodiments, the light panels 250, 251 are shaped similarly to the cavity in which they sit. For example, the light panels 250 of the modular imaging tray 212 are of a long and thin rectangular shape and the light panels 251 of the modular light tray 284 are shaped more similarly to a square.

As also shown in FIG. 12, the housing 211 of the modular imaging tray 212 that defines the central cavity in which the cameras 222 and associated electronics reside. The housing 211 has a generally trapezoidal cross section to facilitate vehicles driving over the modular imaging tray 212. In some embodiments, the housing 211 comprises aluminum, steel, carbon fiber, and/or any suitable material that can withstand the weight of a vehicle driving over it. The housing 211 has a length less than the inside wheel base or track width of common vehicles such that, when the modular imaging tray 212 is positioned on a ground surface, the rectangular clear panel 228 of the modular imaging tray 212 does not get smudged by the tires of the vehicle when passing over the modular imaging tray 212. However, this is not required, and in some embodiments, the housing 211 has a length equal to or greater than the width of the vehicle. For example, in some embodiments, the housing 211 has a length sufficient for cameras 222 to be positioned under the tires of a passing vehicle such that the cameras 222 can capture image or video data of the tires.

The housing 211 of the modular imaging tray 212 encloses the cameras 222, a processor 252, a microphone 254, a light controller 286, and a battery indicator light 294. The processor 252 is communicatively coupled to the microphone 254, the cameras 222, the light controller 286, and/or the battery indicator light 294. The microphone 254 is used to capture audio data of a vehicle as it passes by the modular imaging tray 212. For example, and in some embodiments, the microphone 254 captures audio data from the engine, the brake pads, the wheel bearings, the tires, and/or the suspension of the vehicle.

The processor 252 processes the image, video, and/or audio data acquired by the cameras 222 and the microphone 254. For example, and in some embodiments, the processor 252 transmits the data via WiFi and/or Bluetooth to a user device (not shown), such as a computer or a smart device. In some embodiments, the data sent to the user device is displayed on a display, such as the display 160 described with respect to FIGS. 10A-C. In some embodiments, the processor 222 calculates a tread depth of a tire of a vehicle based on image data of the vehicle acquired by the cameras 222.

In some embodiments, the processor 252 causes one or more of the cameras 222 to zoom, pan, and/or tilt; and in further embodiments, the processor 252 does so in response to a user selecting an input on a user device. In some embodiments, the processor 252 analyzes a video feed of the cameras 222 to determine whether a vehicle is within a field of view of one or more of the cameras 222. In some embodiments, the processor 252 utilizes artificial intelligence and/or machine learning to differentiate between vehicles and other objects, or between different types of vehicles. In some embodiments, the processor 252 causes the cameras 222 to start or stop capturing image and/or video data. In further embodiments, the processor 252 causes the cameras 222 to start or stop capturing image and/or video data in response to the user selecting an input on the user device or in response to a determination that a vehicle is within a field of view of one or more of the cameras 222. In some embodiments, the input selected by the user is indicative of a vehicle being in range of the cameras 222.

Although not shown in FIG. 12, in some embodiments, the processor 252 receives an input from a sensor, such as a proximity sensor, that causes the cameras 222 to start and/or stop capturing image and/or video data. For example, and in some embodiments, the proximity sensor indicates the proximity of a vehicle to the modular imaging system and/or the modular imaging tray 212. In further embodiments, the proximity sensor is one of the cameras 222 or another sensor with the housing 111.

The light controller 286 controls the light panels 250, 251 in the modular imaging tray 212 and/or the modular light tray 284, such as by turning the light panels 250, 251 on and off, and/or by changing the brightness of the light panels 250, 251. For example, and in some embodiments, the light controller 286 turns all or certain of the light panels 250, 251 on or off in response to a signal received from the processor 252. In some embodiments, the processor 252 sends a signal to the light panels 250, 251 when a vehicle enters or exits a field of view of one or more of the cameras 222. In some embodiments, the processor 252 sends a signal to the light panels 250, 251 when the processor 252 receives a signal from a user device, such as when a user selects a button on the user device.

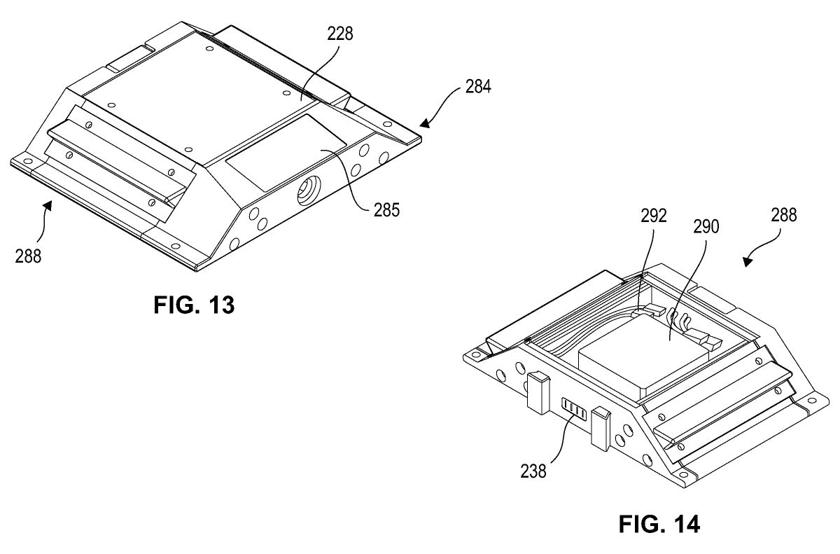

The battery indicator light 294 shown in FIG. 12 is communicatively coupled to the processor 252. However, this is not required, and in some embodiments, the battery indicator light 294 is not communicatively coupled to the processor 252. Although not shown in FIG. 12, the battery indicator light 294 is communicatively coupled to a battery located within the housing 211, or an attached modular battery tray as described in more detail with respect to FIGS. 13 and 14. The battery indicator light 294 indicates the amount of charge remaining in the battery. For example, and in some embodiments, the battery indicator light 294 emits green light when the battery is fully and/or mostly charged, yellow light when the battery has a moderate amount of charge (e.g., 30–60% charged), and red light when the battery has low charge. In some embodiments, the battery indicator light 294 emits light intermittently (i.e., flashes or blinks) when the battery needs to be charged. In some embodiments, the battery indicator light 294 transmits a signal to the processor 252 indicating the charge of the battery and/or whether the battery needs to be charged. In further embodiments, the processor 252 transmits data to a user device to inform a user to charge the battery and/or to indicate the charge of the battery.

In some embodiments, the battery indicator light 294 indicates the state of the modular imaging tray 212. For example, and in some embodiments, the battery indicator light 294 emits a colored light, e.g., green, indicating that the modular imaging tray 212 is powered on; emits a second colored light, e.g., orange, indicating that the modular imaging tray 212 is ready to capture data; and/or emits a third colored light, e.g., red, indicating that there is an issue with the modular imaging tray.

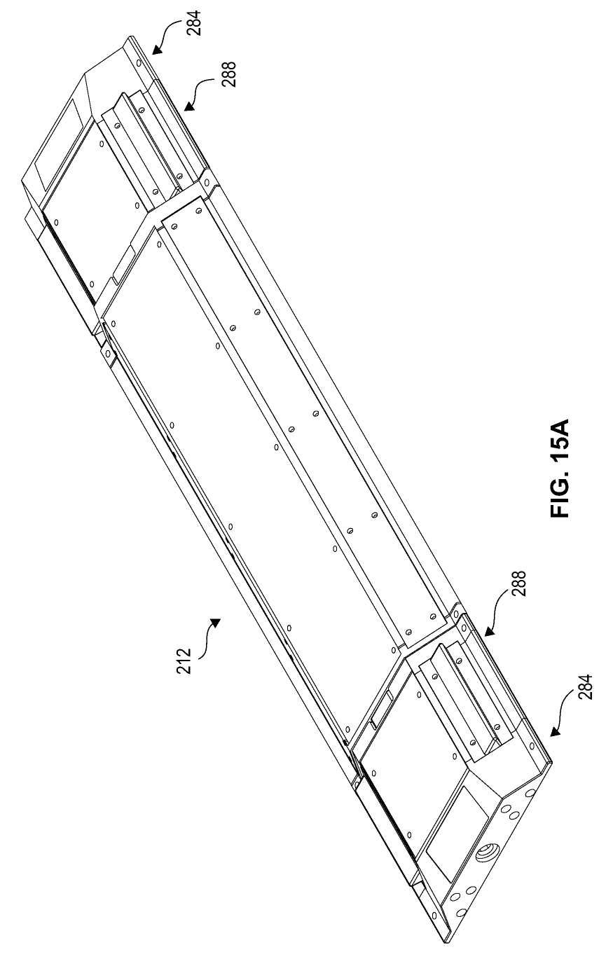

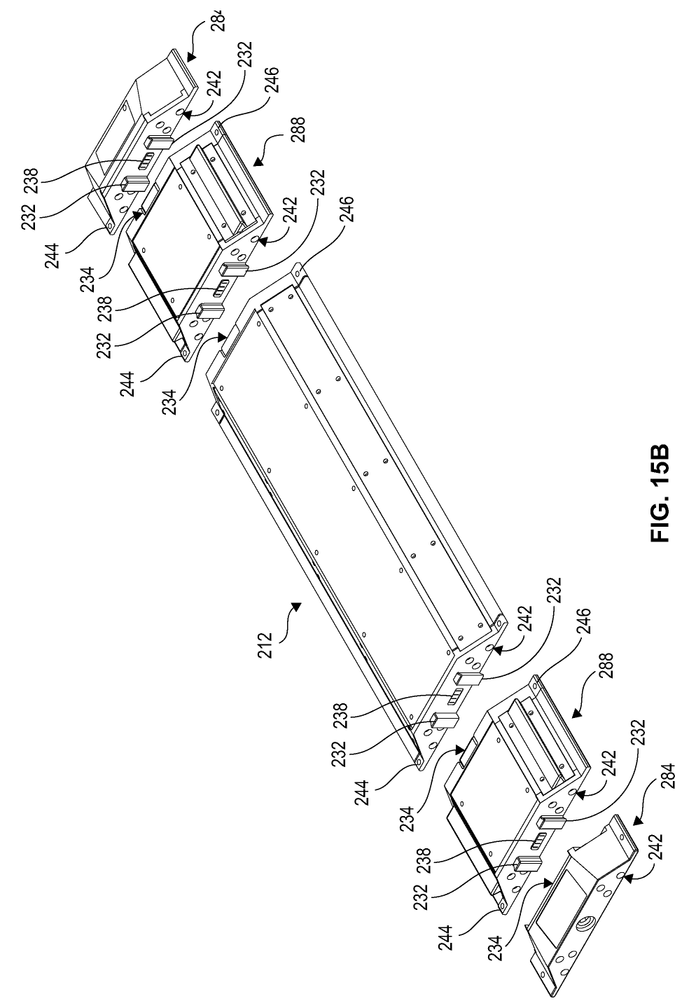

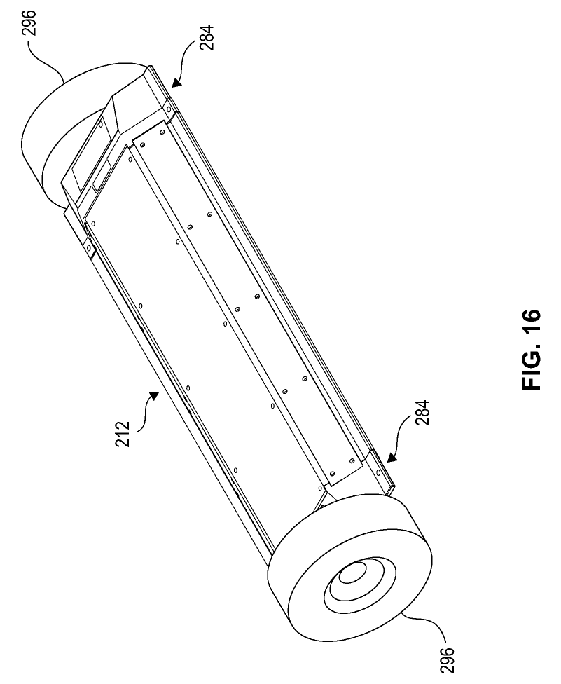

FIG. 13 is a perspective view of a modular battery tray 288 connected to a modular light tray 284. The modular battery tray 288 includes a rectangular clear panel 228 that covers the interior cavity of the modular battery tray 288 and protects the components therein. In addition to being mechanically connected to the modular light tray 284 and/or the modular imaging tray 212 (not shown n FIG. 13), the modular battery tray 288 is electrically connected to the modular light tray 284 and/or the modular imaging tray 213 (see FIGS. 15A–15B) to power the lights 250, 251, cameras 222, and the associated electronics.

FIG. 14 is a perspective interior view of the modular battery tray 288 of FIG. 13. A battery 290 sits within the interior cavity of the modular battery tray 288. The battery 290 is connected to a wired adapter 292 that delivers power to components in the modular imaging trays 212 and/or the modular light trays 284 (not shown in FIG. 14) to which the modular battery tray 288 is connected. The modular battery tray 288 has an electrical connector 238 that electrically connects the modular battery tray 288 to an associated electrical connector 238 of other modular trays 212, 284, 288 (not shown in FIG. 14) to which the modular battery tray 288 is mechanically connected to. For example, and in some embodiments, the wired adapter 292 is connected to the electrical connector 238. Alternatively, in some embodiments, an opening or openings are utilized instead of, or in addition to, the electrical connector 238. In such embodiments, wires connected to the wired adapter 292 and/or battery 290 extend through the opening or openings. For example, and in some embodiments, wires extend through the opening of the electrical connector 238 of the modular battery tray 290 and into respective openings of a modular imaging tray 212 or modular light tray 284 (not shown in FIG. 14). Although not shown in FIG. 14, in some embodiments, the modular battery tray 290 includes a battery indicator light 294.

FIG. 15A is a perspective view of a modular imaging system including a modular imaging tray 212, two modular battery trays 288, and two modular light trays 284. The modular imaging tray 212 has a modular battery tray 288 mechanically and electrically connected to each end of the modular imaging tray 212 so that the modular battery tray 288 can power the components, e.g., light panels 250 and cameras 222, of the modular imaging tray 212. A modular light tray 284 is mechanically and electrically connected to each modular battery tray 288 so that the modular battery tray 288 can power the light panels 251 of the modular light trays 284. In some embodiments, each modular battery tray 288 is capable of powering all of the components of the modular imaging system. For example, and in some embodiments, one of the modular battery trays 288 may be removed (e.g., to charge the battery 290 of that modular battery tray 288) without needing to power off the modular imaging system.

The modular imaging system is not limited to the particular arrangement shown in FIG. 15A because of the modularity of the various trays. For example, in some embodiments, the modular imaging system includes more than one modular imaging tray 212, such as a series of three or four connected modular imaging trays 212 with modular battery trays 288 (and perhaps modular light trays 284) on the two ends of the series of connected imaging trays 212. In some embodiments, each modular imaging tray 212 has one associated battery tray 288 and two associated modular light trays 284 (similar to FIG. 15A, but with one battery tray 288 removed). In some embodiments, the modular imaging system includes only one, or more than one, e.g., two or three modular light trays 284 and/or modular battery trays 288. In some embodiments, the modular imaging system does not include any modular battery trays 288 (for example, it has its own internal battery). In some such embodiments, the modular imaging system utilizes a power cord extending through the modular imaging system to power the internal components therein. In some embodiments, the modular imaging system does not include any modular light trays 284.

FIG. 15B is a perspective view of the modular imaging system of FIG. 15A, with the modular trays 212, 284, 288 disconnected and spaced apart from each other. Each of the ends of the modular trays 212, 284, 288 include electrical connectors 238. In other examples, and in some embodiments, wires extend through openings to supply electricity to the various components within the modular trays 212, 284, 288 instead of the electrical connectors 238 that automatically connect to the electrical connector of the adjacent tray in response to the mating of the mechanical connectors 232, 234. The ends of the modular trays 212, 284, 288 include a male end plate 244 from which projections 232 extend. Opposing ends of the modular trays 212, 284, 288 include a female end plate 246 that define recesses 234 therein. The projections 232 are shaped and configured to be inserted into the recesses 234. For example, and in some embodiments, the projections 232 and recesses 234 have a dove-tail interlocking design. However, this is not required, and in some embodiments, the projections 232 and recesses 234 are of any other suitable shape to mechanically interlock the modular trays 212, 284, 288 to each other. Furthermore, the connection features at the ends of the trays 212, 284, 288 can include fasteners, clips, buckles, or magnetics instead of the recess-projection arrangement. The connection features can be located on the top, bottom, or side surfaces of the trays 212, 284, 288, in addition to the end surfaces of the trays 212, 284, 288.

In some embodiments, the male end plates 244 and the female end plates 246 are monolithic with their respective modular tray 212, 284, 288. However, this is not required, and in some embodiments, the modular trays 212, 284, 288 and the male and female end plates 244, 246 have openings 242 for fasteners to extend therethrough to mechanically couple the modular trays 212, 284, 288 to their respective male and female end plates 244, 246, similar to what is described with respect to FIGS. 3C-D and 4. In some embodiments, a modular tray 212, 284, 288 has no, one, or two male end plates 244. In some embodiments, a modular tray 212, 284, 288 has no, one, or two female end plates 246. In some embodiments, the male end plates 244 and the female end plates 246 are shaped such that the plates 244, 246 are capable of mechanically coupling to each other at an angle with each other. For example, and in some embodiments, the plates 244, 246 are shaped such that the modular trays 212, 284, 288 of which they are a part are at an angle between 90 and 170 degrees, between 100 and 160 degrees, between 110 and 150 degrees, between 120 and 140 degrees, and/or about 130 degrees, with an adjacent modular tray 212, 284, 288. In other words, the modular trays 212, 284, 288 may be positioned along a surface on the same longitudinal axis or on different axes that are angled as noted above. Alternatively, the modular imaging system may also include one or more separate, wedge-shaped angled blocks (having the same male-female mechanical connections, and electrical connections) that fit between adjacent ones of the modular trays 212, 284, 288 to provide the desired angled positioning of the trays.

FIG. 16 is a perspective view of the modular imaging system of FIGS. 11–12 on wheels 296 such that the modular imaging system is mobile. Although the modular imaging system of FIGS. 11–12 is shown in FIG. 16, this is not required. For example, and in some embodiments, different configurations of a modular imaging system include wheels, such as modular imaging systems including one or more modular battery trays 288. Although wheels 296 are shown in FIG. 16, wheels are not required, and in some embodiments, the mobile modular imaging system utilizes treads (like tank treads) or any other suitable structure to mobilize the modular imaging system. In some embodiments, the mobile modular imaging system is placed in front of a vehicle or object to be imaged and the mobile modular imaging system moves under the vehicle or object to capture image, video, and/or audio data of the vehicle or object. In some embodiments, the mobile modular imaging system moves under the vehicle upon a user selecting a button on a user device, such as selecting a button in an application on a smart device. In further embodiments, the mobile modular imaging system stops moving upon the user selecting a button on the user device. In some embodiments, the mobile modular imaging system moves under the center of the width or length of the vehicle. In some such embodiments, the mobile modular imaging system utilizes an AI or machine learning model to keep its path of travel near or at the center of the width or length of the vehicle. In some such embodiments, the AI or machine learning model uses the amount of light received by the cameras 222 of mobile modular imaging system from the sides of the object being imaged as an input. In some embodiments, the VIN of the vehicle is scanned by the cameras 222 of the mobile modular imaging system or by the user device.

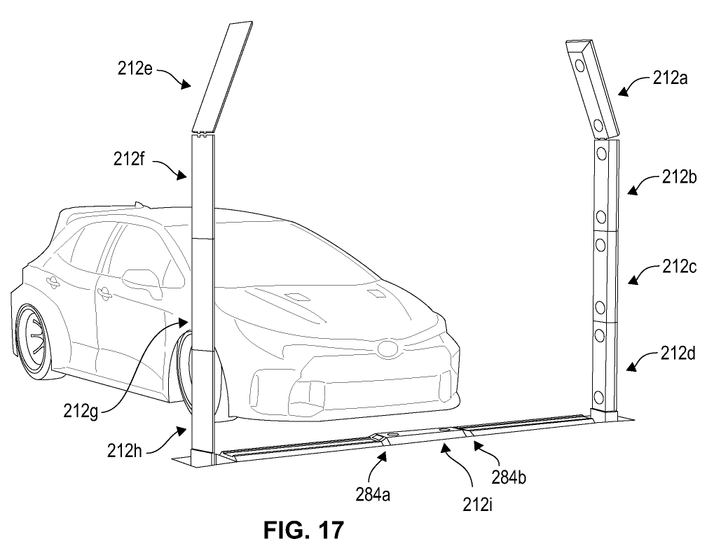

FIG. 17 is a perspective view of a modular imaging system, according to yet another embodiment. The modular imaging system includes nine modular imaging trays 212a–i and two modular light trays 284a–b. Modular imaging trays 212a–d are stacked vertically to image a first side of a vehicle as the vehicle drives past it and modular imaging trays 212e–h are stacked vertically to image a second side of the vehicle as it drives past it. The upper-most imaging trays 212a, 212e are angled slightly downwards towards the vehicle to image a top surface of the vehicle, which can be accomplished by wedge-shaped connecting blocks that connect on the lower sides of trays 212a, 212e. The wedge-shaped connecting blocks may also provide additional lighting directed downwardly toward the vehicle.

The modular imaging system further includes a modular imaging tray 212i with two modular light trays 284a–b connected to opposing ends thereof that is placed on the floor between the two vertical stacks of modular imaging trays 212a–h. The modular light trays 284a–b illuminate an undercarriage of the vehicle as the vehicle passes over the modular imaging tray 212i that images the undercarriage of the vehicle.

In some embodiments, the modular imaging system of FIG. 17 includes one or more structural frames that extend upwardly from the floor to provide support for the two vertical stacks of modular imaging trays 212a–d and 212e-212h. The structural frame can be made of pieces of angle iron that include openings that match openings on the flanges 231 (see FIG. 11) of the modular trays 212, 284, 288 (not all modular trays shown in FIG. 17) to provide more stability. The structural frame may include angled extensions for helping to maintain the positioning of angled trays 212a and 212e.

While modular battery trays 288 are not shown in FIG. 17, in some embodiments, the modular imaging system further includes modular battery trays 288 to provide power to the internal components of the modular imaging trays 212a–i and modular light trays 284a–b. Although FIG. 17 shows one configuration of modular trays 212, 284, this particular configuration is not required, and in some embodiments, the modular imaging system includes different numbers, selections, configurations, or arrangements of modular trays 212, 284, 288. That is one of the advantages of the modular imaging trays 212 (and modular battery trays 288 and modular light trays 284) is that they can be arranged and rearranged in various configurations to best match the functional application and physical space associated with the working environment of the auto dealership, auto auction, rental car rental location, recreational vehicle manufacturing location, etc.

These embodiments and obvious variations thereof are contemplated as falling within the spirit and scope of the claimed invention, which is set forth in the following claims. Moreover, the present concepts expressly include any and all combinations and sub combinations of the preceding elements and aspects.

What is claimed is:

1. A modular imaging system for a vehicle, comprising:
a plurality of modular imaging trays, the plurality of modular imaging trays including a first end and a second end opposite the first end, the first end of one of the plurality of modular imaging trays being connectable to a second end of an adjacent one of the plurality of modular imaging trays, each of the plurality of modular imaging trays including:
a top panel;
one or more cameras for taking images of a vehicle through the top panel;
one or more lighting sources for illuminating the vehicle;
at least one angled side surface adjacent to the top panel that encloses a subset of the one or more lighting sources and transmits light from the subset of the one or more lighting sources toward the vehicle;
a projection on the first end of the modular imaging tray; and
a recess on a second end of the modular imaging tray, the recess shaped to receive the projection of the adjacent one of the plurality of modular imaging trays for connecting the adjacent one of the plurality of modular imaging trays.

2. The modular imaging system of claim 1, wherein each of the modular imaging trays includes an electrical connector at the first and second ends to permit electrical connection between the adjacent modular imaging trays.

3. The modular imaging system of claim 2, further comprising:
an electrical raceway interlocked to at least one of the plurality of modular imaging trays, the electrical raceway allowing for the cables and/or wires to exit the plurality of modular imaging trays at an angle relative to the length dimension.

4. The modular imaging system of claim 1, wherein the plurality of modular imaging trays are stacked vertically and configured to take images of a side of the vehicle via the one or more cameras.

5. The modular imaging system of claim 1, wherein the at least one of the plurality of modular imaging trays further includes a processor and a microphone under the top panel, the processor being communicatively coupled to the one or more cameras, the one or more lighting sources, and the microphone, the processor configured to process images and audio data acquired by the one or more cameras and microphone and to transmit the images and the audio data to a user device.

6. The modular imaging system of claim 1, further including a modular battery tray, the modular battery tray including a battery to provide power to the plurality of modular imaging trays, the modular battery tray being connectable to at least one of the first and second ends of one of the plurality of modular imaging trays.

7. The modular imaging system of claim 1, further including a modular light tray, the modular light tray including at least one light to provide additional lighting on the vehicle for the modular imaging system, the modular light tray being connectable to at least one of the first and second ends of one of the plurality of modular imaging trays.

8. A modular imaging system for a vehicle, comprising:
a modular imaging tray including:
one or more cameras for taking images of a vehicle;
a light controller;
a first connecting feature on a first end of the modular imaging tray; and
a second connecting feature on a second end of the modular imagining tray, the second end being on an opposing side to the first end of the modular imaging tray; and
a modular light tray including:
at least one light panel configured to be controlled by the light controller; and
a light-tray connecting feature for connecting with at least one of the first and second connecting features of the modular imaging tray.

9. The modular imaging system of claim 8, further comprising:
a modular battery tray including:
a battery configured to power the one or more cameras and the at least one light panel; and
a battery-tray connecting feature for connecting with at least one of the first, second, and light-tray connecting features.

10. The modular imaging system of claim 9, wherein the modular imaging tray further includes a processor communicatively coupled to the one or more cameras and the battery, the processor configured to process the images and transmit the images to a user device.

11. The modular imaging system of claim 8, wherein the modular imaging tray further includes a processor configured to activate the one or more cameras, and a sensor communicatively coupled to the processor.

12. The modular imaging system of claim 8, further comprising a plurality of wheels or tank treads configured to move the modular imaging system under the vehicle.

13. The modular imaging system of claim 8, wherein the modular imaging tray and the modular light tray are stacked vertically and configured to take images of a side of the vehicle via the one or more cameras for taking images of a vehicle.

14. The modular imaging system of claim 8, wherein the modular imaging tray further includes angled side surfaces extending lengthwise along the modular imaging tray that enclose one or more lighting sources.

15. The modular imaging system of claim 8, wherein the first and second connecting features include recesses and corresponding projections that are configured to mate with each other.

16. The modular imaging system of claim 8, wherein the first and second connecting features include at least one of fasteners, clips, and buckles.

17. A modular imaging system for a vehicle, comprising:
a modular imaging tray including:
one or more cameras for taking images of a vehicle;
one or more lighting sources for illuminating the vehicle;
a first connecting feature on a first end of the modular imaging tray; and
a second connecting feature on a second end of the modular imagining tray, the second end being on an opposing side to the first end of the modular imaging tray; and
a modular battery tray including:
a battery configured to power the one or more cameras and the one or more lighting sources; and
a battery-tray connecting feature for connecting with at least one of the first and second connecting features of the modular imaging tray.

18. The modular imaging system of claim 17, wherein the first and second connecting features include recesses and corresponding projections that are configured to mate with each other.

19. The modular imaging system of claim 17, wherein the modular imaging tray includes an imaging-tray electrical connector on the first end of the modular imaging tray and the modular battery tray includes a battery-tray electrical connector, the imaging-tray electrical connector and the battery-tray electrical connector configured to electrically connect when the first connecting feature and the battery-tray connecting feature are engaged with each other.

20. The modular imaging system of claim 17, further including a modular light tray connected to the modular battery tray, the modular light tray including at least one light panel.
